(19) United States
(12) Patent Application Publication
(10) Pub. No.: US 2018/0067594 A1
(43) Pub. Date: Mar. 8, 2018

(54) USER INTERFACE ANALYTICS AND CONTEXT USAGE

(71) Applicant: OpenTV, Inc., San Francisco, CA (US)

(72) Inventors: Colin Shengcai Zhao, Sunnyvale, CA (US); Crx K. Chai, Oakland, CA (US); Robert Chen, Mountain View, CA (US)

(21) Appl. No.: 15/697,231

(22) Filed: Sep. 6, 2017

Related U.S. Application Data
(60) Provisional application No. 62/384,487, filed on Sep. 7, 2016.

(51) Int. Cl. G06F 3/048; G06F 9/44; G06F 17/30

(52) U.S. Cl. CPC G06F 3/048; G06F 17/30035; G06F 9/4445

(57) ABSTRACT

Systems and methods for dynamically determining and displaying user interface analytics in a relevant context are provided. The system accesses a plurality of user interfaces of a content provider. The system renders and causes display of a first user interface of the plurality of user interfaces. The system accesses, from a data store, data corresponding to a user interface element on the first user interface. The accessed data is associated with actions performed by users with respect to the user interface element in order to access content provided by the content provider. A conversion result is generated based on the accessed data corresponding to the selected user interface element, whereby the conversion result indicates a percentage of users advancing further in a navigation path based on a selection of the user interface element by the users. The system causes display of the conversion result on the first user interface

### RELATED APPLICATION

The present application claims the priority benefit of U.S. Provisional Patent Application Ser. No. 62/384,487, filed on Sep. 7, 2016 and entitled “User Interface Analytics and Using User Interface for Context,” which is incorporated herein by reference in its entirety.

### FIELD

The present disclosure generally relates to machines configured to the technical field of special-purpose machines that facilitate dynamic analysis and display of information including computerized variants of such special-purpose machines and improvements to such variants, and to the technologies by which such special-purpose machines become improved compared to other special-purpose machines that facilitate analysis and display of information. In particular, the present disclosure addresses systems and methods to dynamically determine and display user interface analytics in a relevant context.

### BACKGROUND

Typically, when an operator of a content provider wants to view information regarding user interface analytics and development of conversion rates for their content being distributed through another party, the operator will receive a generated report. The generated report may be based on information that is stale (e.g., not current). Additionally, the report is not provided in any context for the information being reported.

### BRIEF DESCRIPTION OF DRAWINGS

Various ones of the appended drawings merely illustrate example embodiments of the present invention and cannot be considered as limiting its scope.

FIG. 1 is a diagram illustrating an example environment for dynamically generating and displaying conversion analytics results in a relevant context, in accordance with an example embodiment.

FIG. 2 is a block diagram illustrating an example embodiment of components within a reporting system, in accordance with an example embodiment.

FIG. 3A-FIG. 3D are sample user interfaces illustrating a navigation path to dynamically generate and display conversion analytics results in a relevant context.

FIG. 3E is an example illustrating use of an operator's user interface to display user interface analytics including conversion analytics results.

FIG. 4 is a flow diagram of an example method for dynamically generating and displaying conversion analytics results in a relevant context, in accordance with example embodiments.

FIG. 5 is a diagrammatic representation of a machine in an example form of a computing system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example embodiments described herein provide systems and methods for dynamically generating and displaying user interface conversion analytics in a relevant context. In example embodiments, a reporting system imports user interfaces of a content provider, and renders a user interface for display to an operator of the content provider. In example embodiments, the user interface rendered for display to the operator is a same user interface that a user of the content provider (e.g., viewer, subscriber) is shown. The reporting system receives, from the operator, a selection of a user interface element on the user interface. The reporting system accesses data corresponding to the selected user interface element and generates a conversion analytics result (also referred to as “conversion result”) based on accessed data, whereby the accessed data represents actions performed by users of the content provider (e.g., viewers, subscribers) with respect to the selected user interface element. In example embodiments, the conversion analytics result indicates a result related to a “conversion” of the user (e.g., resulting in the user moving further in a navigation flow, path, or process through a series of user interfaces or resulting in the user ultimately viewing a piece of content)—a percentage of users advancing further in the navigation path. The reporting system overlays on the user interface, analytic conversion results and reports, including but not limited to, distribution of interaction and conversion analytics. The reporting system then causes display of the conversion result on the user interface resulting in the conversion results being displayed in the context of the user interface from which the accessed data is associated. In one embodiment, the display of the conversion result comprises display of an analytics funnel (also referred to as a “funnel diagram”) that is dynamically generated and updated with each successive selection performed by the operator. The analytics funnel comprises a graphical representation of the conversion result.

In alternative embodiments, the reporting system imports user interfaces of the content provider, and renders a user interface for display to the operator of the content provider upon initiating of a conversion analytics process by the operator. The reporting system generates a plurality of conversion results based on accessed data corresponding to the user interface elements on the rendered user interface, whereby the accessed data represents actions performed by users with respect to the rendered user interface. The reporting system then causes display of the plurality of conversion results overlaid over corresponding user interface elements on the user interface.

As a result, one or more of the methodologies described herein facilitate solving the technical problem of dynamically generating and displaying conversion analytics results in the context of the user interfaces that produced the data used to generate the conversion analytics results. In some embodiments, the generating and displaying is dynamic according to selection of actual user interfaces and user interface elements that produced the data used in generating the conversion analytics results. Accordingly, the methodologies allow an operator to view the actual user interfaces that are interacted with by their users, and use navigation of the user interfaces to create, in some embodiments, a funnel diagram comprising one or more conversion results. Thus, the operator can dynamically generate and graphically view conversion results in the context of the user interfaces that produced the data used in generating the conversion results, and build a logical report using a user navigation flow of the user interfaces. The conversion results may represent conversion analytics results for a position or real estate where a user interface element is located, a specific user interface element (e.g., size, design), or a specific piece of content that is shown in the user interface element (e.g., a specific movie, show, or piece of content).

By using embodiments of the present invention, the operator can dynamically generate user interface conversion analytics results and view the analytics results in the context of one or more user interfaces that produced the data used in generating the conversion analytics results. Accordingly, one or more of the methodologies discussed herein may obviate a need for separately viewing user interfaces and real time conversion analytics results using two different systems (e.g., a user interface displaying system and a reporting system), which may have the technical effect of reducing computing resources used by one or more devices within the system. Examples of such computing resources include, without limitation, processor cycles, network traffic, memory usage, storage space, and power consumption.

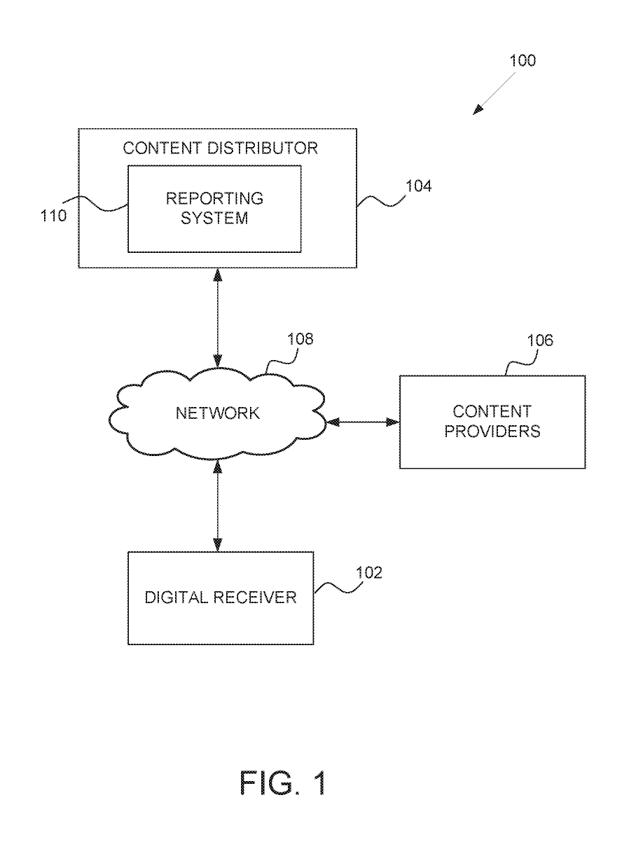

With reference to FIG. 1, an embodiment of an example environment 100 that enables dynamic generation and display of conversion analytics results is shown. In example embodiments, a digital receiver 102 of a user (e.g., viewer, subscriber, or user of content providers 106) provides access to digital content. In one embodiment, the digital receiver 102 is a set-top box. The digital receiver 102 is coupled to a viewing device, such as a television or monitor (not shown) on which the user can view the digital content. In some embodiments, the digital receiver 102 may be combined with the viewing device (e.g., a smart television, a mobile device).

In example embodiments, a content distributor 104 (e.g., comprising a headend) manages content distribution from the content providers 106, via a network 108, to the digital receivers 102. In particular, the content distributor 104 tracks user interactions performed at the digital receiver 102, with respect to various user interfaces and user interface elements, to access content from the content providers 106. In some embodiments, the data may be provided by the digital receivers 102 (e.g., as device data) to the content distributor 104. In other embodiments, the content distributor 104 monitors the interactions performed at the digital receivers 102 with respect to the user interfaces and the user interface elements to detect the data. The data is stored to a data store of a reporting system 110.

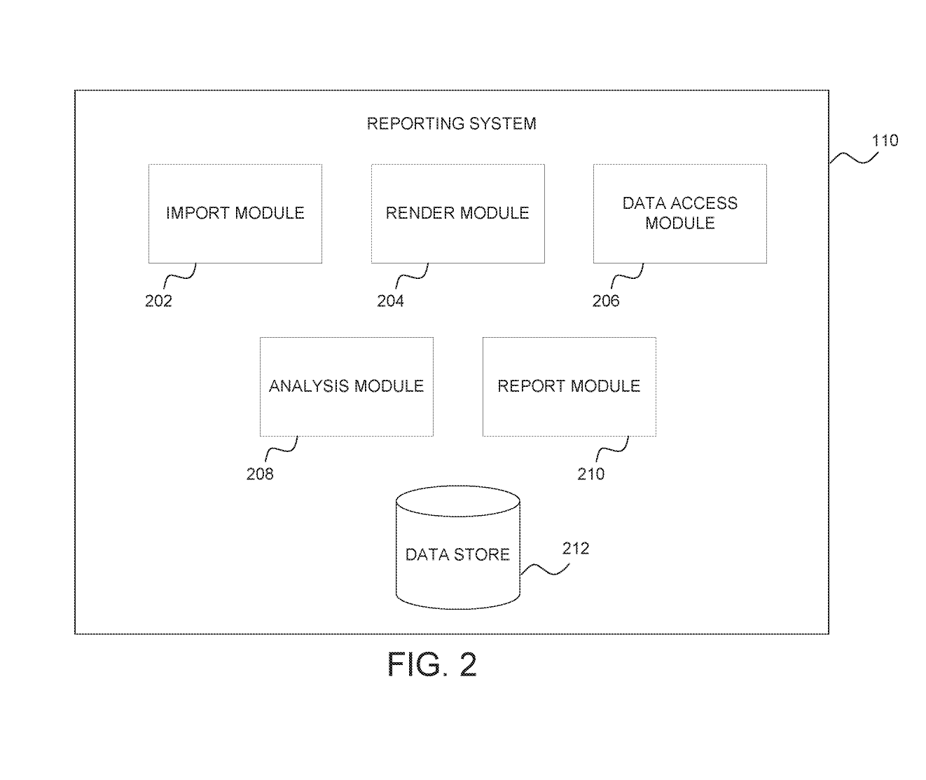

The reporting system 110 manages the dynamic generation and display of conversion analytics (also referred to as “conversion analytics results”) using actual user interfaces (or a copy or version of user interfaces displayed to the users) that produced the data (e.g., data regarding the tracked or monitored user interactions) used in generating the conversion analytics. The reporting system 110 will be discussed in more detail in connection with FIG. 2.

One or more portions of the network 108 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks. Any one or more portions of the network 108 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In example embodiments, the content providers 106 comprise third party services (e.g., Netflix, Hulu, YouTube, Amazon) that store and provide content (e.g., over-the-top (OTT) content or video-on-demand (VOD)) to the content distributor 104 or the digital receiver 102 via the network 108. The content comprises audio/video content (e.g., movies, television shows). In example embodiments, an operator of a content provider 106 triggers the reporting system 110 to dynamically generate and display the conversion analytics as will be discussed in more detail below.

It is noted that the environment 100 shown in FIG. 1 is merely an example. For instance, any number of content providers 106 may be embodied within the environment 100. Additionally, some components of the environment 100 may be combined, or operations discussed as occurring at the content distributor 104 or reporting system 110 may be performed at the content provider 106 or vice-versa. For example, the content distributor 104 may provide some of the functionalities of the reporting system 110 to the content providers 106 such that the content providers 106 can, for example, perform the conversion analytics process. Therefore, a portion of the reporting system 110 may be located at the content provider and/or the digital receiver 102 in alternative embodiments.

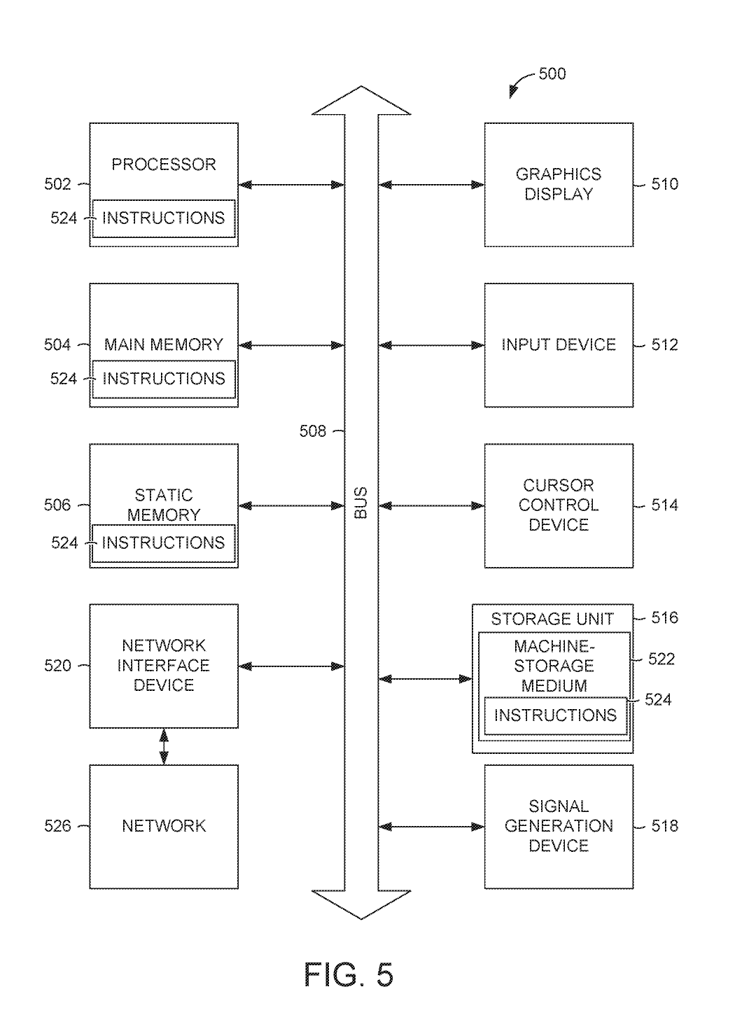

Any of the systems or machines (e.g., databases, devices, servers) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 5, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines. Moreover, any two or more of the systems or machines illustrated in FIG. 1 may be combined into a single system or machine, and the functions described herein for any single system or machine may be subdivided among multiple systems or machines.

FIG. 2 is a block diagram illustrating an example embodiment of the reporting system 110. In example embodiments, the reporting system 110 dynamically generates and displays conversion analytics on one or more user interfaces that produced the data used in generating the conversion analytics. In alternative embodiments, the reporting system 110 uses the operator's user interface to display conversion analytic results. In some embodiments, the generating and displaying is dynamic according to selections of the user interfaces or user interface elements, by the operator, that produces the data used in generating the conversion analytics. To enable these operations, the reporting system 110 comprises an import module 202, a render module 204, a data access module 206, an analysis module 208, a report module 210, and at least one data store 212 all of which may be configured to communicate with each other (e.g., over a bus, shared memory, or a switch).

Any one or more of the components (e.g., modules) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices. For example, some of the components may be embodied within the reporting system 110 while others are embodied within the digital receiver 102 or the content providers 106. The reporting system 110 may comprise other components not pertinent to example embodiments that are not shown or discussed.

The import module 202 imports user interfaces from the content provider 106. In example embodiments, the user interfaces are built in HTML5, Cascading Style Sheets (CSS), or JavaScript (JS). As a result, the same user interfaces can be rendered by the reporting system 110 as those shown to users on which the users interact to access content provided by the content provider 106. In one embodiment, the import module 202 imports the user interfaces when an operator of the content provider 106 triggers a conversion analytics process of the reporting system 110. In example embodiments, the user interfaces are the current user interfaces. Additionally or alternatively, any changes or updates to the user interfaces are automatically made.

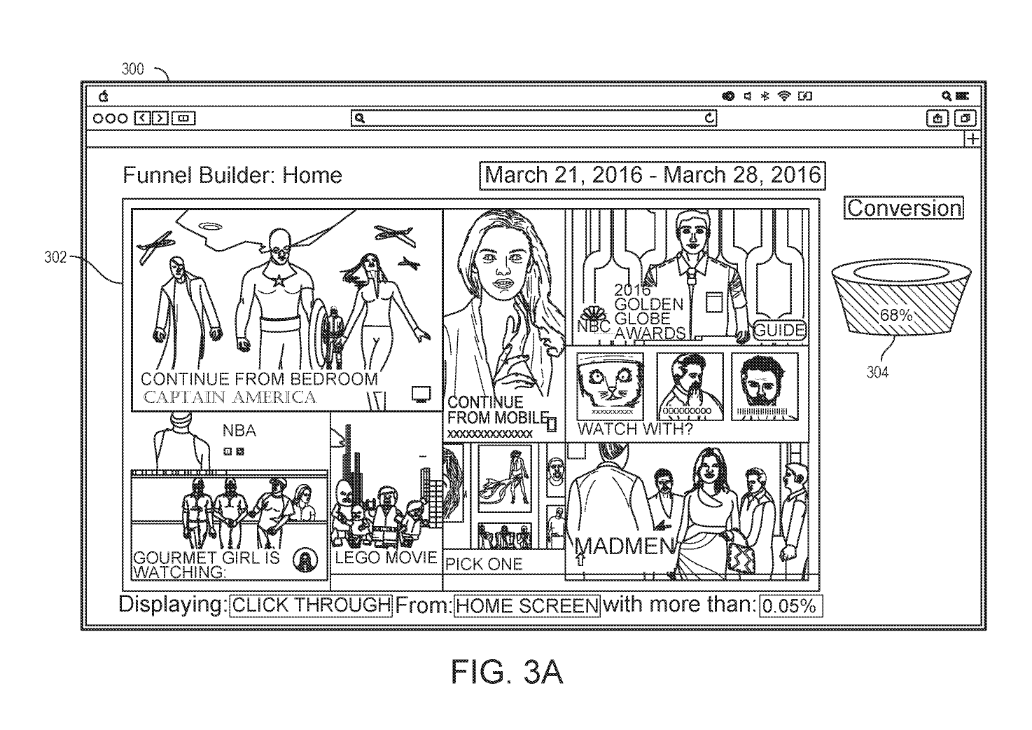

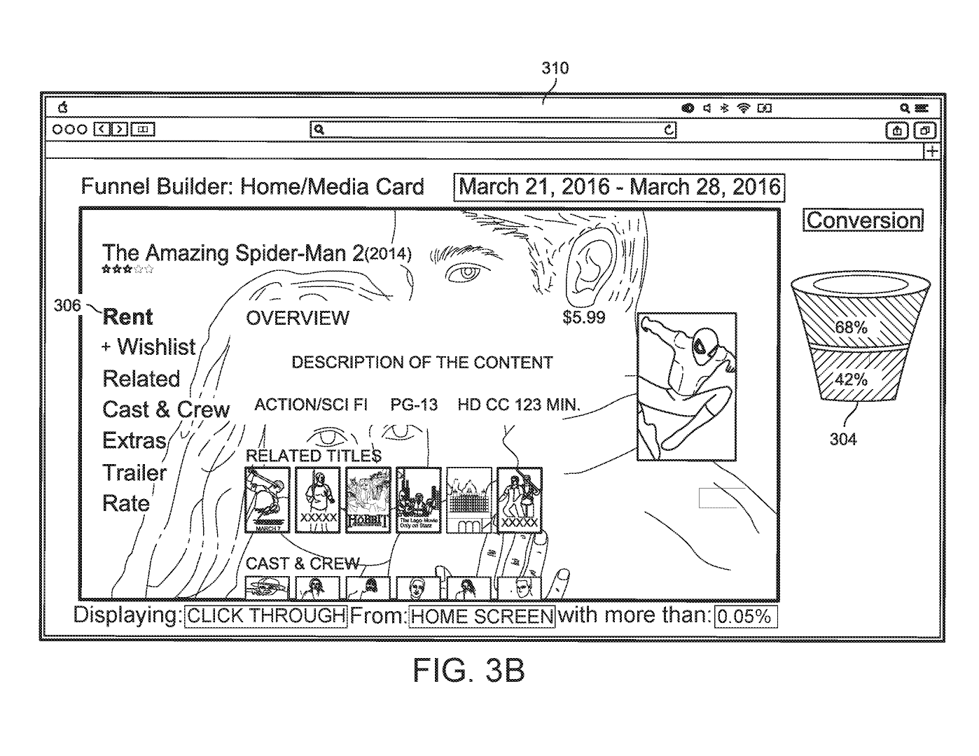

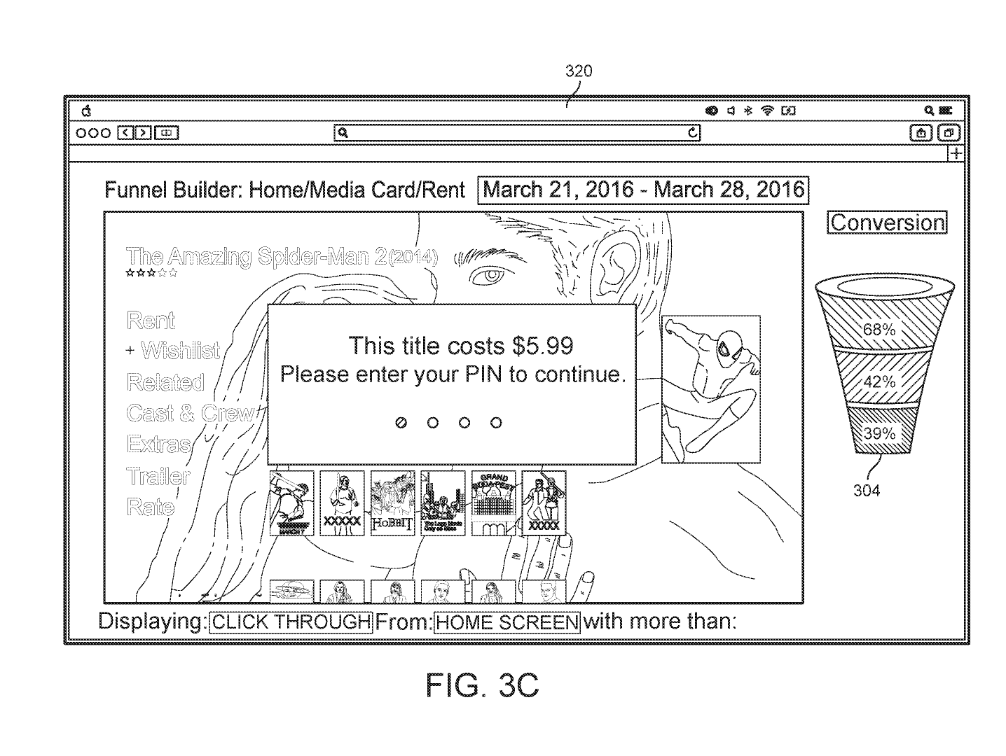

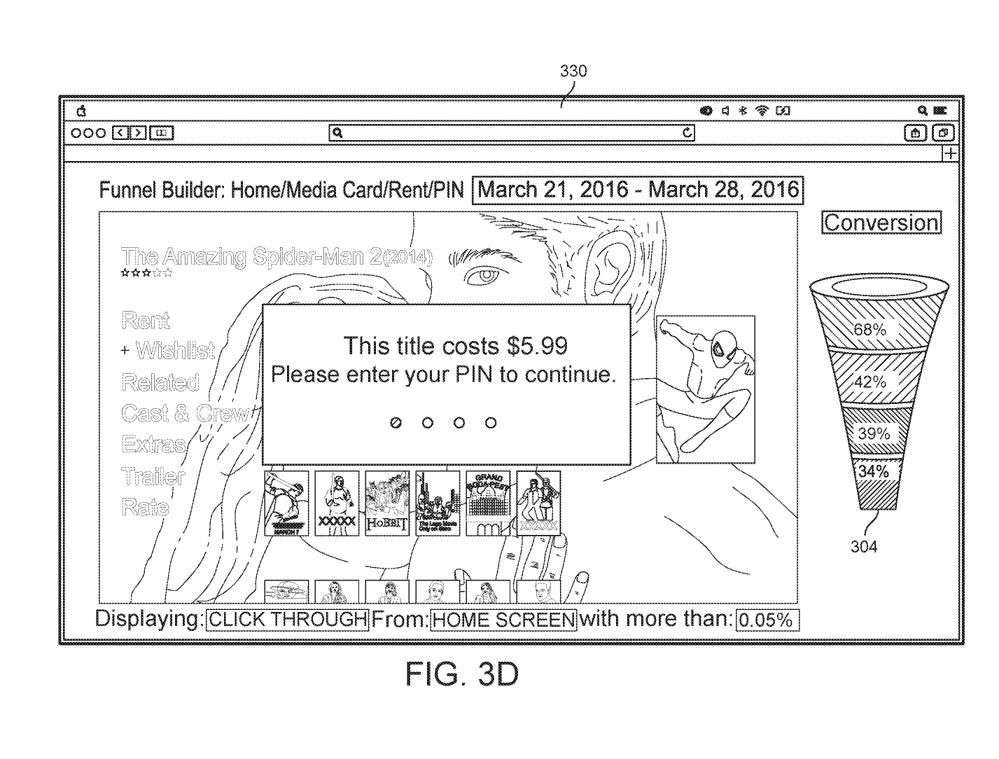

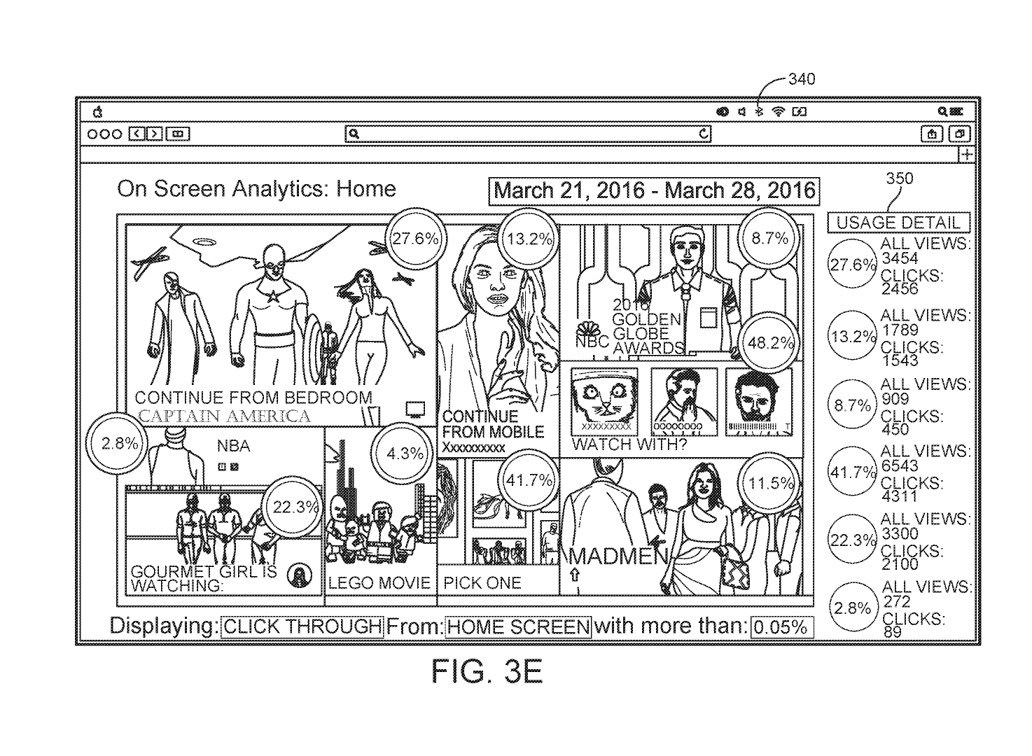

The render module 204 renders the user interfaces that are imported by the import module 110. In example embodiments, all of the user interfaces are represented so that an operator (e.g., back office personnel) of the content provider 106 sees exactly what users see when interacting with the user interfaces to access content provided by the content provider 106. The user interfaces are navigable to allow the operator to use a navigation path to dynamically generate the conversion analytics and display a funnel diagram of the conversion analytics. The operator sees the user interfaces and clicks on (e.g., selects) the same controls or user interface elements a user would use. The navigation or click path reflects in a displayed funnel diagram with one or more conversion results illustrating how a user population followed the same selected navigation or click path. An example illustrating a sample navigation of user interfaces is shown and described in FIG. 3A-3D below.

The data access module 206 accesses corresponding data stored in the data store 212 in response to each selection within the user interfaces. The data comprises information regarding a number of views, clicks (e.g., selections), or other interactions (e.g., providing authorization) performed by users with respect to each user interface or user interface element. In some embodiments, the data is generated (e.g., user interactions tracked and monitored) by the content provider 106 and transmitted to the reporting system 110 (e.g., periodically or when the user interfaces are imported by the import module 202) for storage in the data store 212. In other embodiments, the data is generated (e.g., user interactions tracked or monitored) by the digital receivers 102 of the users and transmitted to the reporting system 110 (e.g., periodically transmitted or transmitted in response to an event such as a selection by the user at the digital receiver 102) for storage in the data store 212. In yet other embodiments, the data may be generated (e.g., user interactions tracked or monitored) by the content distributor 104. Regardless of how the data is obtained, the accessed data is provided by the data access module 206 to the analysis module 208.

The analysis module 208 performs the conversion analytics process. In example embodiments, the analysis module 208 receives parameters from the operator to customize the conversion analytics process. For example, a user interface may be provided (e.g., by the render module 204) that allows the operator to indicate a time of day or day of week for which the operator wants the conversion results to be analyzed. Other parameters used to customize the conversion analytics process may include, for example, geography, demographics of users, types of products (e.g., content type—movie, show, video), packages (e.g., users subscribed to sports package, user subscribed to certain premium channels), genres, actors, types of hardware (e.g., watched on a mobile device, watched via a digital receiver and television), or some control group. In some cases, the conversion analytics process may be based on a random test or set of parameters. The analysis module 208 then generates the conversion result for each selection or navigation. Using the conversion results, the report module 210 generates and graphically presents the conversion results. In example embodiments, the conversion results are used to generate a funnel diagram that is graphically displayed on a corresponding user interface that produced the data used in generating the conversion analytic results, in accordance with some embodiments.

FIG. 3A-FIG. 3D are sample user interfaces illustrating a click or navigation path to dynamically generate conversion analytics results (also referred to as “conversion results”) and generate and display a conversion funnel diagram in the context of the user interface that provided the data used to generate the conversion results. The user interfaces are generated by the render module 204 based on imported user interfaces from the content provider 106. Referring to FIG. 3A, a home screen user interface 300 is shown. In example embodiments, the home screen user interface 300 is a first user interface rendered and caused to be displayed to the operator. The render module 204 generates and displays the home screen user interface 300. The operator, in this example, clicks or selects a user interface element 302 (e.g., “Captain America” component/element) located in the top left corner of the user interface 300. In response, the data access module 206 accesses data from the data store 212 related to the selected user interface element 302 (e.g., number of views, number of selections of the selected user interface element 302), and the analysis module 208 generates the conversion result. In this example, 68% of users that accessed the home screen user interface 300 (also referred to herein as “original users”) selected the same user interface element 302 on the home screen user interface 300. In other words, 68% of users that were shown the home screen user interface 300 selected the “Captain America” element. The report module 210 generates a conversion funnel 304 (also referred to as a “funnel diagram”) that is displayed on the user interface 300 that indicates this conversion result.

Referring now to FIG. 3B, a media card user interface 310 rendered by the render module 204 is shown. The operator, in this example, has navigated to a next user interface from the home screen user interface 300 based on a selected user interface element (e.g., a selection of an element associated with particular piece of content) and is shown the media card for that piece of content (e.g., “The Amazing Spider Man 2” or “Captain America”). In the present example, the operator selected a user interface element on the home screen interface 300 associated with “The Amazing Spider Man 2” and is presented with a media card user interface 310 for “The Amazing Spider Man 2.”

In some embodiments, the operator selects a further user interface element on the media card user interface 310 to obtain a next conversion result. In response to the selection of the next user interface element, the data access module 206 accesses data from the data store 212 related to the media card user interface 310, and the analysis module 208 generates a conversion result for the next user interface element. In other embodiments, the media card user interface 310 may comprise only a single conversion user interface element, selection of which would be considered a “conversion” of the user (e.g., an action that would result in the user moving further in the navigation process to eventually view the content). In the example of FIG. 3B, a conversion occurs if the user selects a “rent” element 306. Since the “rent” element 306 is the only selection that would “convert” the user (e.g., move the user closer to viewing the content), operator selection of the “rent” element 306 is not needed in order to trigger the conversion analytics process (e.g., detection of the single conversion user interface element by the analysis module 208 causes the automatic generation of the conversion result). As such, the data access module 206 automatically accesses data from the data store 212 related to the “rent” element 306, and the analysis module 208 generates a conversion result for this next user interface element. Here, for example, 42% of the original users are converted (e.g., continue the navigation process to the next screen to rent/view the piece of content). The report module 210 updates the conversion funnel 304 that is displayed on the user interface 310 to reflect this next conversion result. It is noted that detection of a single conversion user interface element may occur on any of the user interfaces imported, obtained, or accessed from the content providers (e.g., a first user interface or home screen user interface, a second user interface, and so forth).

Referring now to FIG. 3C, a rent user interface 320 rendered by the render module 204 is shown. The operator, in this example, has navigated to a next user interface from the media card user interface 310 based on the selection of the “rent” element 306 in order to rent the piece of content displayed in the media card user interface 310. The operator is shown the rent user interface 320 where a user can enter a PIN to authorize renting (e.g., payment) of the piece of content. In the present example, the rent user interface 320 comprises a single element (also referred to as the “single conversion user interface element”) which would be considered a “conversion” of the user (e.g., an action that would result in the user moving further in the navigation process towards viewing the content)—that is to provide payment via entering a PIN. As such, the data access module 206 accesses data from the data store 212 related to the rent user interface 320 and, in particular, data related to a number of users that entered a PIN on the rent user interface 310. The analysis module 208 uses the accessed data to generate the conversion result for the rent user interface 320. In this example, conversion occurs if the user enters a PIN (e.g., makes payment). Here, 39% of the original users are converted (e.g., continues the navigation process to the next screen by entering a PIN or payment). The report module 210 updates the conversion funnel 304 that is displayed on the rent user interface 320 to reflect this next conversion result.

Referring now to FIG. 3D, an authorization user interface 330 rendered by the render module 204 is shown. The operator, in this example, has navigated to a next user interface from the rent user interface 320 based on providing an authorization to rent the piece of content in the rent user interface 320. In the present example, the authorization is an entered personal identifier number (PIN) that is verified to complete the rental transaction. Alternative embodiments may utilize other forms of authorization such as, for example, a password or credit card number. In example embodiments, the data access module 206 accesses data from the data store 212 related to the authorization user interface 330 (e.g., number of users that authorized the renting of the piece of content), and the analysis module 208 generates the conversion result. In this example, 34% of the original users are converted (e.g., authorizes the renting of the piece of content and completes the transaction). The report module 210 updates the conversion funnel 304 that is displayed on the authorization user interface 330 to reflect this next conversion result. As shown, from the home screen user interface 300, 34% of the original viewers are converted (e.g., completed the rental transaction) using the same navigation path that the operator just navigated. As a result, the operator can view percentages of the original users that continued through a particular navigation path to complete a transaction with respect to a piece of content or real estate (e.g., location) using the conversion funnel 304 (also referred to as “funnel diagram”).

FIG. 3E is an alternative user interface 340 (e.g., a home screen user interface) the user interface 340 illustrates heat map statistics (e.g., user access distribution on the user interface screen) that show, given a user interface screen, what are the most popular click destinations on that user interface screen (e.g., most popular portion of screen or real estate). In one embodiment, an overlaid statistic on each user interface element indicates a corresponding conversion rate (e.g., resulting in viewing of the corresponding piece of content associated with the user interface element) for that particular user interface element. For example, an element of “Continue Watching from Bedroom” had a conversion rate of 27.6%, which indicates that 27.6% of the users that select the “Continue Watching from Bedroom” from the user interface 340 continued on a navigation path to continue watching the piece of content associated with the “Continue Watching from Bedroom” element. Normally, these statistics are shown as graphs or charts. In this embodiment, however, the actual (home screen) user interface 340 is used to show the statistics in context. From the user interface 340, if the operator navigates to a next screen one level lower (e.g., by selecting one of the user interface elements), the operator will see a new user interface with a different set of corresponding statistics overlaid on that screen.

A portion of the user interface 340 provides usage details 350. The usage details are color coordinated with each graphically overlaid statistic, so that the operator can easily correlate the usage detail 350 with its user interface element. In example embodiments, the user interface is dynamic, meaning that depending on the operator, different content, can be displayed to the user. The reporting allows the operator to view in context, both the popularity of the real estate (e.g., portion of the user interface screen) and the actual dynamic user interface element (be it a piece of content, a feature, or a button). “All views” refers to how many times that particular user interface element was shown to users, while “clicks” indicates a number of times that user interface element was acted upon (e.g., selected) by users.

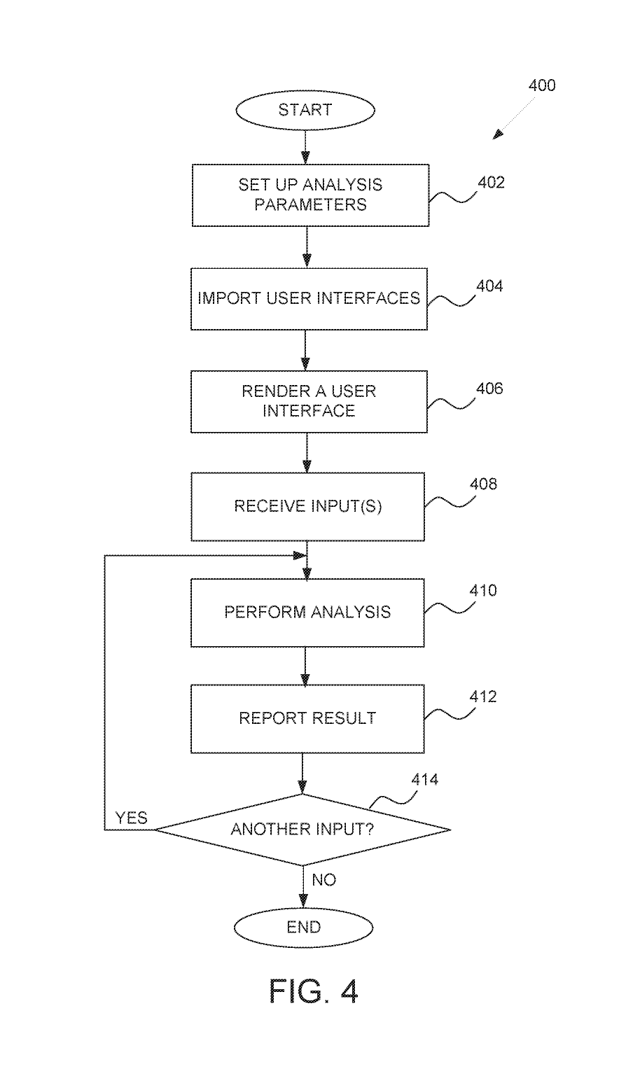

FIG. 4 is a flow diagram of an example method 400 for dynamically generating and displaying conversion analytics results (or conversion results) in accordance with example embodiments. In example embodiments, the method 400 is performed in part or in whole by components of the reporting system 110. Accordingly, the method 400 is described by way of example with reference to the reporting system 110. However, it shall be appreciated that at least some of the operations of the method 400 may be deployed on various other hardware configurations or be performed by similar components residing elsewhere in the environment 100. Therefore, the method 400 is not intended to be limited to the reporting system 110.

In operation 402, an operator of a content provider (e.g., content provider 106) sets up analysis parameters that apply to the conversion analytics process that occurs using example embodiments. In example embodiments, the analysis module 208 receives the parameters from the operator to customize the conversion analytics process. The set up may use any combination of default setting and customized setting provided by the operator and may occur at any time. Once the setup of the analysis parameters is established, the same parameters may be used for a subsequent analytics process. As such, operation 402 may not occur every time the operator triggers the conversion analytics process. The parameters may include, for example, a time of day or day of week, geography, demographics of users, types of products (e.g., content type—movie, show, video), packages (e.g., users subscribe to sports package, users subscribe to certain premium channels), genres, actors, or types of hardware (e.g., watched on mobile, watched via a digital receiver).

In operation 404, user interfaces of a content provider 106 are imported by the import module 202. In example embodiments, the user interfaces are built in HTML5, Cascading Style Sheets (CSS), or JavaScript (JS). In one embodiment, the import module 202 imports the user interfaces when an operator of the content provider 106 triggers the conversion analytics process of the reporting system 110. As such, the user interfaces are the current user interfaces of the content provider 106. Additionally or alternatively, any changes or updates to the user interface may be automatically applied. In other embodiments, the user interfaces are imported prior to the content provider 106 triggering the conversion analytics process.

In operation 406, a user interface is rendered by the render module 204. In one embodiment, the first user interface rendered comprises a home screen user interface from which an operator may navigate along a same navigation path as their respective users. This allows the operator of the content provider 106 to see exactly what their users see when interacting with the user interfaces to access content provided by the content provider 106. As such, the user interfaces are navigable to allow the operator to use the navigation path to dynamically generate the conversion analytics results and display, for example, a funnel diagram of the conversion analytics. The operator sees the user interfaces and clicks on the same controls a user can use.

In operation 408, an input is received from the operator. The input comprises a navigation such as a selection of a user interface element displayed on a current user interface (e.g., the home screen user interface) that is being displayed to the operator.

In operation 410, analysis is performed by the analysis module 208 based on the input. In example embodiments, the data access module 206 access corresponding data stored in the data store 212 in response to the input (e.g., data that corresponds to the input or selected user interface element). The accessed data is provided to the analysis module 208. The analysis module 208 determines the conversion analytics result(s) using the accessed data (e.g., based on number of user selections, inputs, click-thrus, or authorizations). For example, the analysis module 208 may divide a number of times that the user interface element was selected by the users by a number of times the user interface element was shown to the users.

In operation 412, the conversion results are reported by the report module 210. In example embodiments, the report module 210 generates and presents (e.g., overlays or appends) a funnel diagram on the corresponding user interface using the conversion results.

In operation 414, a determination is made as to whether another input is received. For example, the operator performs another navigation or selects a user interface element on a current user interface to navigate to a next user interface or on a next user interface that results from the received input of operation 408. If there is another input, the method 400 returns to operation 410. In embodiments where a next user interface only has a single conversion user interface element, a next input is not needed to trigger the conversion analytics process of operation 410.

In the alternative embodiment with respect to FIG. 3E, operations 402-406 are performed. Operation 408 is not required. Instead, the conversion analytics analysis in operation 410 is performed for each user interface element shown on the user interface rendered and shown in operation 406. The results are then reported, in operation 412, by overlaying the results (e.g., conversion rate) on each interactive user interface element on the user interface.

FIG. 5 is a block diagram illustrating components of a machine 500, according to some example embodiments, able to read instructions 524 from a machine-storage medium 522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 5 shows the machine 500 in the example form of a computer device (e.g., a computer) within which the instructions 524 (e.g., software, a program, an application, an applet, an app, or other executable code) for causing the machine 500 to perform any one or more of the methodologies discussed herein may be executed, in whole or in part.

For example, the instructions 524 may cause the machine 500 to execute the flow diagram of FIG. 4. The instructions 524 can transform the general, non-programmed machine 500 into a particular machine (e.g., specially configured machine) programmed to carry out the described and illustrated functions in the manner described.

In alternative embodiments, the machine 500 operates as a standalone device or may be connected (e.g., networked) to other machines. The machine 500 may be a server computer, a client computer, a personal computer (PC), a tablet computer, a laptop computer, a netbook, a set-top box (e.g. STB), a personal digital assistant (PDA), a cellular telephone, a smartphone, a web appliance, a network router, a network switch, a network bridge, a power adapter, or any machine 500 capable of executing the instructions 524, sequentially or otherwise, that specify actions to be taken by that machine 500. Further, while only a single machine 500 is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or other pointing instrument), a storage unit 516, a signal generation device 518 (e.g., a sound card, an amplifier, a speaker, a headphone jack, or any suitable combination thereof), and a network interface device 520.

The storage unit 516 includes the machine-storage medium 522 (e.g., a tangible machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-storage media 522 (e.g., tangible and non-transitory machine-readable media).

In some example embodiments, the machine 500 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 504, 506, and/or memory of the processor(s) 502) and/or storage unit 516 may store one or more sets of instructions and data structures (e.g., software) 524 embodying or utilized by any one or more of the methodologies or functions described herein. These instructions, when executed by processor(s) 502 cause various operations to implement the disclosed embodiments.

As used herein, the terms “machine-storage medium,” “device-storage medium,” “computer-storage medium” (referred to collectively as “machine-storage medium 522”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 522 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 522 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 524 may further be transmitted or received over a communications network 526 using a transmission medium via the network interface device 520 and utilizing any one of a number of well-known transfer protocols (e.g., HTTP). Examples of communication networks 526 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 524 for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium 522 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 502 or a group of processors 502) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

### Examples

Example 1 is a method for dynamically determining and displaying user interface analytics in a relevant context. The method comprises accessing a plurality of user interfaces of a content provider; rendering and causing display of a first user interface of the plurality of user interfaces; accessing, from a data store, data corresponding to a user interface element on the first user interface, the accessed data being associated with actions performed by users with respect to the user interface element in order to access content provided by the content provider; generating, using a hardware processor, a conversion result based on the accessed data corresponding to the selected user interface element, the conversion result indicating a percentage of users advancing further in a navigation path based on a selection of the user interface element by the users; and causing display of the conversion result on the first user interface.

In example 2, the subject matter of example 1 can optionally include wherein the causing the display of the conversion result comprises generating and displaying a funnel diagram on the first user interface.

In example 3, the subject matter of examples 1-2 can optionally include wherein the accessing and generating is automatically performed in response to detecting a single conversion user interface element on the first user interface.

In example 4, the subject matter of examples 1-3 can optionally include receiving, from an operator, a selection of the user interface element on the first user interface, the accessing the data, generating the conversion result, and causing display being in response to the receiving of the selection of the user interface element.

In example 5, the subject matter of examples 1-4 can optionally include rendering and causing display of a second user interface of the plurality of user interfaces, the second user interface being a next user interface after the first user interface in a navigation path; receiving a selection of a user interface element on the second user interface; accessing, from the data store, data corresponding to the selected user interface element on the second user interface; generating a further conversion result based on the accessed data corresponding to the selected user interface element on the second user interface; and causing display of the further conversion result on the second user interface, the causing display of the further conversion result comprising adding the further conversion result to the conversion result.

In example 6, the subject matter of examples 1-5 can optionally include rendering and causing display of a second user interface of the plurality of user interfaces, the second user interface being a next user interface after the first user interface in a navigation path; detecting a single conversion user interface element on the second user interface; in response to the detecting the single conversion user interface element automatically accessing, from the data store, data corresponding to the single user interface element on the second user interface; automatically generating a further conversion result based on the accessed data corresponding to the single user interface element on the second user interface; and causing display of the further conversion result on the second user interface, the causing display of the further conversion result comprising adding the further conversion result to the conversion result.

In example 7, the subject matter of examples 1-6 can optionally include wherein the causing the display of the further conversion result comprises updating a funnel diagram of the first user interface with the further conversion result for display on the second user interface.

In example 8, the subject matter of examples 1-7 can optionally include wherein the accessing the data comprising accessing data corresponding to a plurality of user interface elements on the first user interface; the generating the conversion result comprises generating a conversion result for each of the plurality of user interface elements based on the accessed data corresponding to the plurality of user interface elements; and the causing display comprises causing display of the conversion result for each of the plurality of user interface elements overlaid over its respective user interface element.

In example 9, the subject matter of examples 1-8 can optionally include causing display of usage details on a portion of the first user interface, the usage details including a number of times the user interface element was shown to the users and a number of times that the user interface element was selected by the users.

Example 10 is a system for dynamically determining and displaying user interface analytics in a relevant context. The system includes one or more processors and a memory storing instructions that, when executed by the one or more hardware processors, causes the one or more hardware processors to perform operations comprising accessing a plurality of user interfaces of a content provider; rendering and causing display of a first user interface of the plurality user interfaces; accessing, from a data store, data corresponding to a user interface element on the first user interface, the accessed data being associated with actions performed by users with respect to the user interface element in order to access content provided by the content provider; generating a conversion result based on the accessed data corresponding to the selected user interface element, the conversion result indicating a percentage of users advancing further in a navigation path based on a selection of the user interface element by the users; and causing display of the conversion result on the first user interface.

In example 11, the subject matter of example 10 can optionally include wherein the causing the display of the conversion result comprises generating and displaying a funnel diagram on the first user interface.

In example 12, the subject matter of examples 10-11 can optionally include wherein the accessing and generating is automatically performed in response to detecting a single conversion user interface element on the first user interface.

In example 13, the subject matter of examples 10-12 can optionally include wherein the operations further comprise receiving, from an operator, a selection of the user interface element on the first user interface, the accessing the data, generating the conversion result, and causing display being in response to the receiving of the selection of the user interface element.

In example 14, the subject matter of examples 10-13 can optionally include rendering and causing display of a second user interface of the plurality of user interfaces, the second user interface being a next user interface after the first user interface in a navigation path; receiving a selection of a user interface element on the second user interface; accessing, from the data store, data corresponding to the selected user interface element on the second user interface; generating a further conversion result based on the accessed data corresponding to the selected user interface element on the second user interface; and causing display of the further conversion result on the second user interface, the causing display of the further conversion result comprising adding the further conversion result to the conversion result.

In example 15, the subject matter of examples 10-14 can optionally include rendering and causing display of a second user interface of the plurality of user interfaces, the second user interface being a next user interface after the first user interface in a navigation path; detecting a single conversion user interface element on the second user interface; in response to the detecting the single conversion user interface element automatically accessing, from the data store, data corresponding to the single user interface element on the second user interface; automatically generating a further conversion result based on the accessed data corresponding to the single user interface element on the second user interface; and causing display of the further conversion result on the second user interface, the causing display of the further conversion result comprising adding the further conversion result to the conversion result.

In example 16, the subject matter of examples 10-15 can optionally include wherein the causing the display of the further conversion result comprises updating a funnel diagram of the first user interface with the further conversion result for display on the second user interface.

In example 17, the subject matter of examples 10-16 can optionally include the accessing the data comprising accessing data corresponding to a plurality of user interface elements on the first user interface; the generating the conversion result comprises generating a conversion result for each of the plurality of user interface elements based on the accessed data corresponding to the plurality of user interface elements; and the causing display comprises causing display of the conversion result for each of the plurality of user interface elements overlaid over its respective user interface element.

In example 18, the subject matter of examples 10-17 can optionally include wherein the operations further comprise causing display of usage details on a portion of the first user interface, the usage details including a number of times the user interface element was shown to the users and a number of times that the user interface element was selected by the users.

Example 19 is a machine-storage medium for dynamically determining and displaying user interface analytics in a relevant context. The machine-storage medium configures one or more processors to perform operations comprising accessing a plurality of user interfaces of a content provider; rendering and causing display of a first user interface of the plurality of user interfaces; accessing, from a data store, data corresponding to a user interface element on the first user interface, the accessed data being associated with actions performed by users with respect to the user interface element in order to access content provided by the content provider; generating a conversion result based on the accessed data corresponding to the selected user interface element, the conversion result indicating a percentage of users advancing further in a navigation path based on a selection of the user interface element by the users; and causing display of the conversion result on the first user interface.

In example 20, the subject matter of example 19 can optionally include wherein the causing the display of the conversion result comprises generating and displaying a funnel diagram on the first user interface.

Although an overview of the inventive subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
accessing, a plurality of user interfaces of a content provider;
rendering and causing display of a first user interface of the plurality of user interfaces;
accessing, from a data store, data corresponding to a user interface element on the first user interface, the accessed data being associated with actions performed by users with respect to the user interface element in order to access content provided by the content provider;
generating, using a hardware processor, a conversion result based on the accessed data corresponding to the selected user interface element, the conversion result indicating a percentage of users advancing further in a navigation path based on a selection of the user interface element by the users; and
causing display of the conversion result on the first user interface.

2. The method of claim 1, wherein the causing the display of the conversion result comprises generating and displaying a funnel diagram on the first user interface.

3. The method of claim 1, wherein the accessing and generating is automatically performed in response to detecting a single conversion user interface element on the first user interface.

4. The method of claim 1, further comprising receiving, from an operator, a selection of the user interface element on the first user interface, the accessing the data, generating the conversion result, and causing display being in response to the receiving of the selection of the user interface element.

5. The method of claim 1, further comprising:
rendering and causing display of a second user interface of the plurality of user interfaces, the second user interface being a next user interface after the first user interface in a navigation path;
receiving a selection of a user interface element on the second user interface;
accessing, from the data store, data corresponding to the selected user interface element on the second user interface;
generating a further conversion result based on the accessed data corresponding to the selected user interface element on the second user interface; and
causing display of the further conversion result on the second user interface, the causing display of the further conversion result comprising adding the further conversion result to the conversion result.

6. The method of claim 1, further comprising:
rendering and causing display of a second user interface of the plurality of user interfaces, the second user interface being a next user interface after the first user interface in a navigation path;
detecting a single conversion user interface element on the second user interface;
in response to the detecting the single conversion user interface element:
automatically accessing, from the data store, data corresponding to the single user interface element on the second user interface;
automatically generating a further conversion result based on the accessed data corresponding to the single user interface element on the second user interface; and
causing display of the further conversion result on the second user interface, the causing display of the further conversion result comprising adding the further conversion result to the conversion result.

7. The method of claim 6, wherein the causing the display of the further conversion result comprises updating a funnel diagram of the first user interface with the further conversion result for display on the second user interface.

8. The method of claim 1, wherein:
the accessing the data comprising accessing data corresponding to a plurality of user interface elements on the first user interface;
the generating the conversion result comprises generating a conversion result for each of the plurality of user interface elements based on the accessed data corresponding to the plurality of user interface elements; and
the causing display comprises causing display of the conversion result for each of the plurality of user interface elements overlaid over its respective user interface element.

9. The method of claim 1, further comprising causing display of usage details on a portion of the first user interface, the usage details including a number of times the user interface element was shown to the users and a number of times that the user interface element was selected by the users.

10. A system comprising:
one or more hardware processors; and
a memory storing instructions, that when executed by the one or more hardware processors, cause the one or more hardware processors to perform operations comprising:
accessing a plurality of user interfaces of a content provider;
rendering and causing display of a first user interface of the plurality user interfaces;
accessing, from a data store, data corresponding to a user interface element on the first user interface, the accessed data being associated with actions performed by users with respect to the user interface element in order to access content provided by the content provider;
generating a conversion result based on the accessed data corresponding to the selected user interface element, the conversion result indicating a percentage of users advancing further in a navigation path based on a selection of the user interface element by the users; and
causing display of the conversion result on the first user interface.

11. The system of claim 10, wherein the causing the display of the conversion result comprises generating and displaying a funnel diagram on the first user interface.

12. The system of claim 10, wherein the accessing and generating is automatically performed in response to detecting a single conversion user interface element on the first user interface.

13. The system of claim 10, wherein the operations further comprise receiving, from an operator, a selection of the user interface element on the first user interface, the accessing the data, generating the conversion result, and causing display being in response to the receiving of the selection of the user interface element.

14. The system of claim 10, wherein the operations further comprise:
rendering and causing display of a second user interface of the plurality of user interfaces, the second user interface being a next user interface after the first user interface in a navigation path;
receiving a selection of a user interface element on the second user interface;
accessing, from the data store, data corresponding to the selected user interface element on the second user interface;
generating a further conversion result based on the accessed data corresponding to the selected user interface element on the second user interface; and
causing display of the further conversion result on the second user interface, the causing display of the further conversion result comprising adding the further conversion result to the conversion result.

15. The system of claim 10, wherein the operations further comprise:
rendering and causing display of a second user interface of the plurality of user interfaces, the second user interface being a next user interface after the first user interface in a navigation path;
detecting a single conversion user interface element on the second user interface;
in response to the detecting the single conversion user interface element:
automatically accessing, from the data store, data corresponding to the single user interface element on the second user interface;
automatically generating a further conversion result based on the accessed data corresponding to the single user interface element on the second user interface; and
causing display of the further conversion result on the second user interface, the causing display of the further conversion result comprising adding the further conversion result to the conversion result.

16. The system of claim 15, wherein the causing the display of the further conversion result comprises updating a funnel diagram of the first user interface with the further conversion result for display on the second user interface.

17. The system of claim 10, wherein:
the accessing the data comprising accessing data corresponding to a plurality of user interface elements on the first user interface;
the generating the conversion result comprises generating a conversion result for each of the plurality of user interface elements based on the accessed data corresponding to the plurality of user interface elements; and
the causing display comprises causing display of the conversion result for each of the plurality of user interface elements overlaid over its respective user interface element.

18. The system of claim 10, wherein the operations further comprise causing display of usage details on a portion of the first user interface, the usage details including a number of times the user interface element was shown to the users and a number of times that the user interface element was selected by the users.

19. A machine-storage medium storing instructions that when executed by one or more hardware processors of a machine, cause the machine to perform operations comprising:
accessing a plurality of user interfaces of a content provider;
rendering and causing display of a first user interface of the plurality of user interfaces;
accessing, from a data store, data corresponding to a user interface element on the first user interface, the accessed data being associated with actions performed by users with respect to the user interface element in order to access content provided by the content provider;
generating a conversion result based on the accessed data corresponding to the selected user interface element, the conversion result indicating a percentage of users advancing further in a navigation path based on a selection of the user interface element by the users; and
causing display of the conversion result on the first user interface.

20. The machine-storage medium of claim 19, wherein the causing the display of the conversion result comprises generating and displaying a funnel diagram on the first user interface.
